(19) United States
(12) Patent Application Publication
(10) Pub. No.: US 2004/0140420 A1
(43) Pub. Date: Jul. 22, 2004

(54) Image sensor having increased number of pixels

(76) Inventors: Ken Dai, Hsinchu Hsien (TW); Swallow Lai, Hsinchu Hsien (TW)

Correspondence Address: PRO-TECHTOR INTERNATIONAL, 20775 Norada Court, Saratoga, CA, 95070-3018, US

(21) Appl. No.: 10/346,767

(22) Filed: Jan. 16, 2003

(51) Int. Cl. H01J 40/14

(52) U.S. Cl. 250/214 R

(57) ABSTRACT

An image sensor having increased number of pixels. The image sensor includes a substrate, a frame layer, a photosensitive chip, wires, an adhesive medium and a transparent layer. The substrate has an upper surface and a lower surface. The frame layer is arranged on the upper surface of the substrate to form a cavity together with the substrate. The photosensitive chip is arranged within the cavity and is mounted to the upper surface of the substrate. The wires electrically connect the photosensitive chip to the substrate. The adhesive medium is inside the cavity. The transparent layer is arranged on the frame layer to cover the image sensor. Thus, the particles inside the cavity fall down and are adhered to the adhesive medium without being distributed over the sensitive area of the photosensitive chip and the transparent layer. Therefore, the number of good pixels of the sensor may be increased.

### BACKGROUND OF THE INVENTION

1. Field of the Invention

The invention relates to an image sensor having an increased number of pixels, and in particular to an image sensor in which the number of particles may be reduced to improve the sensor capability and produce an image sensor possessing a higher resolution.

2. Description of the Related Art

A general sensor is used for sensing signals that may be image signals or audio signals. The sensor of the invention is used to receive image (optical) signals and convert the image signals into electrical signals that are to be transmitted to a printed circuit board.

Referring to FIG. 1, a conventional image sensor includes a substrate 10, a frame layer 18, a photosensitive chip 26, wires 28, and a transparent layer 34. The substrate 10 has an upper surface 12 on which first terminals 15 are formed, and a lower surface 14 on which second terminals 16 are formed. The frame layer 18 has an upper surface 20 and a lower surface 22 adhered to upper surface 12 of the substrate 10 to form a cavity 24 together with the substrate 10. The photosensitive chip 26 is arranged within the cavity 24 and is mounted to the upper surface 12 of the substrate 10. Each wire 28 has a first terminal 30+20 and a second terminal 32. The first terminals 30 are electrically connected to the photosensitive chip 26, and the second terminals 32 are electrically connected to the first terminals 15 of the substrate 10. The transparent layer 34 is adhered to the upper surface 20 of the frame layer 18.

However, the image sensor has to be manufactured in a clean room in order to prevent particles from entering the cavity 24 and to increase the number of good pixels. Even if the image sensor is manufactured in a clean room, a few particles may enter the cavity 24 to influence the quality of the pixels of the image sensor. Thus, the manufacturers have to spend a lot of money to heighten the level of the clean room so as to prevent any particles from entering the image sensor.

### SUMMARY OF THE INVENTION

An object of the invention is to provide an image sensor having an increased number of pixels, in which the number of particles of the image sensor may be greatly decreased.

To achieve the above-mentioned objects, the image sensor of the invention includes a substrate, a frame layer, a photosensitive chip, wires, an adhesive medium and a transparent layer. The substrate has an upper surface and a lower surface. The frame layer is arranged on the upper surface of the substrate to form a cavity together with the substrate. The photosensitive chip is arranged within the cavity and is mounted to the upper surface of the substrate. The wires electrically connect the photosensitive chip to the substrate. The adhesive medium is inside the cavity. The transparent layer is arranged on the frame layer to cover the image sensor.

Thus, the particles inside the cavity may fall down and be adhered to the adhesive medium without being distributed over the sensitive area of the photosensitive chip and the transparent layer. Therefore, the number of good pixels of the image sensor may be increased.

### BRIEF DESCRIPTION OF THE DRAWINGS

FIG. 1 is a cross-sectional view showing a conventional image sensor.

FIG. 2 is a cross-sectional view showing an image sensor with an increased number of pixels according to an embodiment of the invention.

FIG. 3 is a schematic illustration showing the image sensor of the embodiment of the invention.

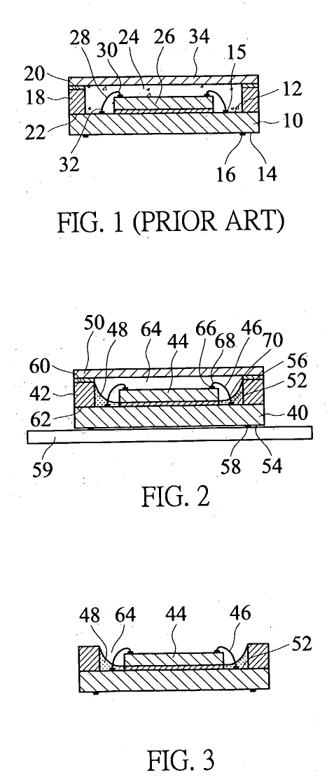

### DETAILED DESCRIPTION OF THE INVENTION

Referring to FIG. 2, an image sensor of the invention includes a substrate 40, a frame layer 42, a photosensitive chip 44, wires 46, an adhesive medium 48 and a transparent layer 50.

The substrate 40 has an upper surface 52 on which first connection points 56 are formed, and a lower surface 54 on which second connection points 58 are formed. The second connection points 58 are electrically connected to a printed circuit board 59.

The frame layer 42 has a first surface 60 and a second surface 62 adhered to the upper surface 52 of the substrate 40 to form a cavity 64 together with the substrate 10.

The photosensitive chip 44 is formed with bonding pads 66, arranged inside the cavity 64 formed by the substrate 40 and the frame layer 42, and mounted to the upper surface 52 of the substrate 40.

Each of the wires 46 has a first terminal 68 and a second terminal 70. The first terminals 68 are electrically connected to the bonding pads 66 of the photosensitive chip 44, and the second terminals 70 are electrically connected to the first connection points 56 of the substrate 40, respectively, so as to transfer signals from the photosensitive chip 44 to the substrate 40.

In this embodiment, the adhesive medium 48 may be glue applied to the upper surface 52 within the cavity 64 by coating or spraying.

The transparent layer 50 is a piece of transparent glass arranged on the first surface 60 of the frame layer 42 to cover the photosensitive chip 44. Then, the photosensitive chip 44 may receive optical signals passing through the transparent layer 50.

After the transparent layer 50 is adhered to the frame layer 42, particles inside the cavity 64 fall down slowly and are adhered to the adhesive medium 48. In addition, the image sensor may be slightly shaken so that the particles above the sensitive area of the photosensitive chip 44 may fall down and adhered to the adhesive medium. At this time, no particle inside the cavity 64 may influence the sensitive capability of the photosensitive chip 44, and the number of good pixels may be increased.

Referring to FIG. 3, the method for manufacturing the image sensor of the invention includes the following steps. First, after the photosensitive chip 44 is mounted inside the cavity 64, wires 46 are bonded. Then, the adhesive medium 48 is applied to the upper surface 52 of the substrate by coating or spraying. Next, the transparent layer 50 is adhered to the frame layer 42. Thereafter, the particles inside the cavity 64 fall down and are adhered to the adhesive medium 48. Then, an image sensor with an increased number of pixels is produced.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An image sensor to be electrically connected to a printed circuit board, the image sensor comprising:
a substrate having a lower surface and an upper surface on which first connection points are formed;
a frame layer arranged on the upper surface of the substrate to form a cavity together with the substrate;
a photosensitive chip, on which bonding pads are formed, arranged within the cavity and mounted to the upper surface of the substrate;
wires for electrically connecting the bonding pads of the photosensitive chip to the first connection points of the substrate, respectively;
an adhesive medium inside the cavity; and
a transparent layer arranged on the frame layer to cover the photosensitive chip.

2. The image sensor according to claim 1, further comprising second connection points, which are electrically connected to the printed circuit board and are formed on the lower surface of the substrate.

3. The image sensor according to claim 1, wherein the adhesive medium is coated onto the upper surface of the substrate.

4. The image sensor according to claim 1, wherein the transparent layer is a piece of transparent glass.

5. The image sensor according to claim 1, wherein the adhesive medium is formed inside the cavity by spraying or coating.
